(19) United States
(12) Patent Application Publication
(10) Pub. No.: US 2009/0294747 A1
(43) Pub. Date: Dec. 3, 2009

(54) ADJUSTABLE GATE MOUNT

(76) Inventor: Edward J. Stull, Oxford, MI (US)

Correspondence Address: CARLSON, GASKEY & OLDS, P.C., 400 WEST MAPLE ROAD, SUITE 350, BIRMINGHAM, MI, 48009, US

(21) Appl. No.: 12/472,740

(22) Filed: May 27, 2009

Related U.S. Application Data
(60) Provisional application No. 61/056,110, filed on May 27, 2008.

(51) Int. Cl. E04H 17/16; E05D 7/04

(52) U.S. Cl. 256/73; 16/236

(57) ABSTRACT

An example gate assembly is supported on a fixed structure by upper and lower mounting brackets. The upper and lower brackets provide adjustment of the gate assembly without need for removing any mount and reduce the need for shimming or other disassembly of the gate to provide alignment.

This application claims priority to U.S. Provisional Application No. 61/056,110 which was filed on May 27, 2008.

### BACKGROUND OF THE INVENTION

Conventional gate assemblies include first and second gates that rotate about a fixed point, such as a pillar. A gap between the two closing gates is typically adjusted by shimming the hinges that support each of the gates. Over time, the pillars or gates may sag, requiring additional adjustment. The adjustment of the gates can be particularly difficult for heavy estate sized gates. Further assembly and adjustment for a gate installer of estate-sized gates can be very difficult in that the entire process must be repeated until a desired alignment is obtained.

Accordingly, it is desirable to design and develop an adjustable gate mount that allows for adjustment of gates without disassembly of hinges or removal of the mounted gate.

### SUMMARY OF THE INVENTION

A disclosed gate mounting assembly includes an upper and lower bracket that includes features for aligning a gate within an opening.

An example gate assembly is supported on a fixed structure by upper and lower mounting brackets. The upper and lower brackets provide for alignment of the gates such that a gap between each of the gates can be adjusted. The upper portion of the rotating post includes a pin that fits within a cavity of the upper support post. The upper mount receives the pin and thereby supports and maintains the gate in the desired aligned position. The pin includes a beveled feature to compensate for misalignment between the upper and lower mounts.

The lower mount includes a clamp portion that clamps around a lower portion of the gate. Clamping is provided on a portion of the lower gate maintains support while still providing for rotation of the gate. Adjustment of the gate assembly provides for movement of each of the gates to align each of the gates within the opening.

Accordingly, the configuration of the upper and lower mount assemblies as disclosed provide adjustment of gate assemblies without need for removing any mount or reduces or substantially eliminates the needs for any shimming or other disassembly of the gate to provide alignment.

These and other features of the present invention can be best understood from the following specification and drawings, the following of which is a brief description.

### BRIEF DESCRIPTION OF THE DRAWINGS

FIG. 1 is a schematic view of a gate assembly.

FIG. 1A is an enlarged view of a top mount portion of the gate assembly.

FIG. 1B is an enlarged view of a bottom mount portion of the gate assembly.

FIG. 2 is a perspective view of an upper adjustable mount.

FIG. 3 is a side view of the upper adjustable mount.

FIG. 4 is a front view of the upper adjustable mount.

FIG. 5 is a bottom view of the upper adjustable mount.

FIG. 6 is an exploded view of the adjustable mount.

FIG. 7 is a side and front view of the adjustable mount.

FIG. 8 is a side and front view of an insert portion of the adjustable mount.

FIG. 9 is a perspective view of the lower adjustable mount.

FIG. 10 is a top view of the lower adjustable mount.

FIG. 11 is a front view of the lower adjustable mount.

FIG. 12 is a side view of the lower adjustable mount.

FIG. 13 is an exploded view of a portion of the lower adjustable mount.

FIG. 14 is a front and side view of a portion of the lower adjustable mount.

### DETAILED DESCRIPTION OF THE PREFERRED EMBODIMENT

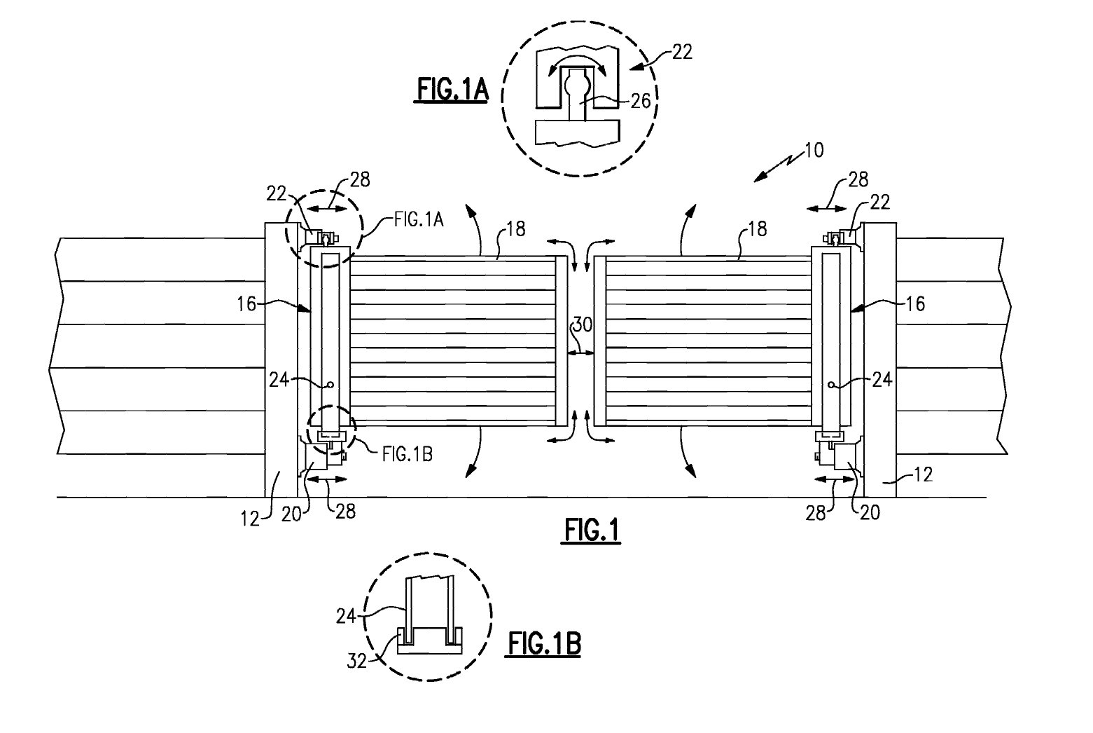

Referring to FIG. 1, a gate assembly 10 includes support posts 12 that are part of a fence 14. The support posts 12 are mounted within the ground and support a rotating post 16. The rotating post 16 in turn supports gates 18. A lower mount 20 is attached to the support post 12 and an upper mount 22 is also attached to each support post 12. The rotating post 16 is supported by the lower mount 20 and the upper mount 22.

Attached to the rotating posts 16 are the gates 18. The gates 18 extend outwardly from the rotating post 16 to a central portion of the opening. A gap 30 between each of the gates is adjusted by utilizing adjustment features provided by the upper and lower mounts 20, 22.

The support posts 16 include an inner support 24. The inner support 24 fits within a portion of the lower mount 20. The inner support post 24 is a cylindrical post that extends from the lower adjustment mount 20 upward toward the upper mount 22. An outer post fits over the inner support post 24 and rotates relative to the inner support post 24.

Referring to FIG. 1A, the upper portion of the rotating post 16 includes a pin 26 that fits within a cavity of the upper support post 22. The upper mount 22 receives the pin 26 and thereby supports and maintains the gate 18 in the desired aligned position. The pin 26 includes a beveled feature to compensate for misalignment between the upper and lower mounts 20, 22.

The lower mount 20 includes a clamp portion 32 that clamps around the inner support tube 24. The clamping on the inner support tube to the lower mount 20 maintains a support in a non-rotational position to allow the outer portion of the rotating post 16 to rotate relative to the inner support tube 24.

Both the upper mount 22 and the lower mount 20 are adjustable in a direction indicated at 28. The adjustment indicated at 28 allows for movement of each of the gates 18 in a direction to align the gap 30 between the gates 18.

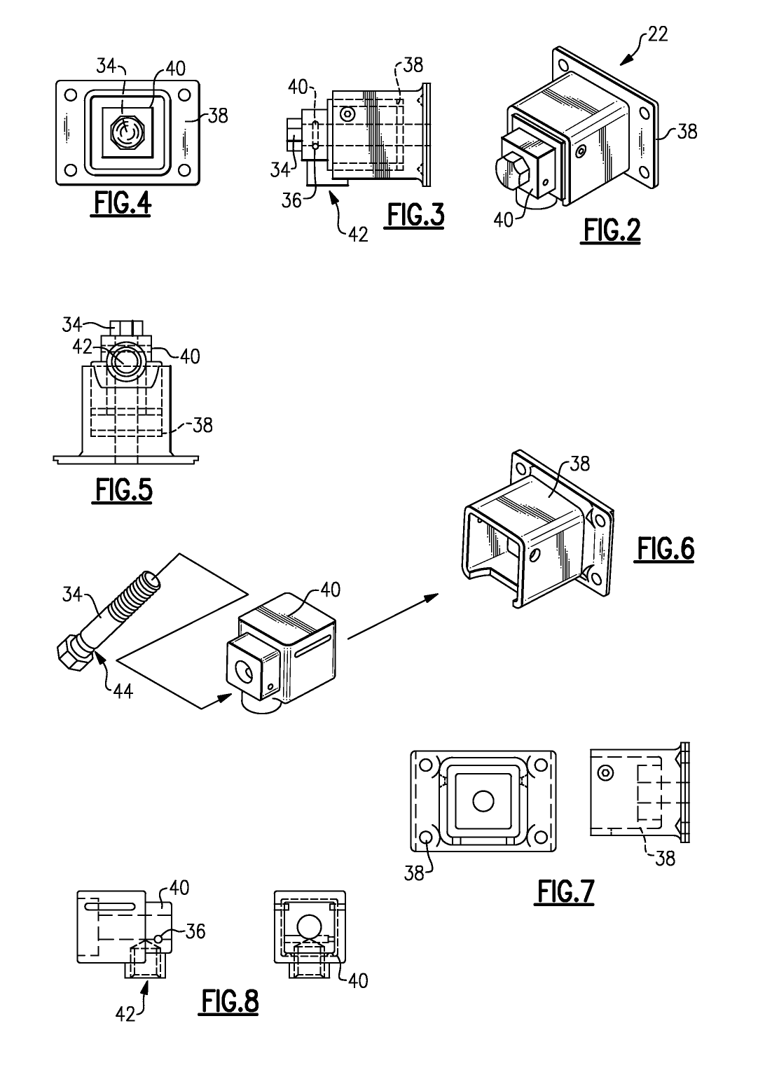

Referring to FIG. 2-5 with continued reference to FIG. 1, the upper mount 22 includes a mount plate 38 and an inner housing assembly 40. The inner housing assembly 40 is moveable relative to the mount plate 38. The mount plate 38 includes a plate having a plurality of openings for threaded fasteners or other type of fasteners to secure the upper mount 22 to one of the support posts 12 or other structure that is utilized to support the gate 18. Movement of the inner housing 40 relative to the mount plate 38 is facilitated by rotation of a threaded member 34. The threaded member 34 supported within the inner housing and secured for rotation within the inner housing or by a dowel pin 36. The mount plate 38 also includes a cavity within which the adjustable inner housing moves. The inner housing of the upper mount 22 includes a cavity 42 that receives the pin 26. This cavity is disposed within the movable portion of the inner housing assembly 40.

Adjusting nut 34 is a threaded member that extends through the inner housing 40 and is received within a threaded portion of the mount plate 38. The adjusting nut 34 is pinned to prevent movement relative to the inner housing 40. Rotation of the adjustment nut 34 provides for movement of the inner housing 40 relative to the mount plate 38.

Referring to FIGS. 6, 7 and 8 with continued reference to FIG. 1, the upper mount 22 is shown in an exploded view including the mount plate 38. The mount plate 38 is shown with a cavity that receives the inner housing assembly 40. The inner housing assembly 40 includes an opening within which the adjusting member is received. The adjusting member 34 includes a slot 44 that is engaged by the dowel pin that is extended through corresponding openings within the inner housing 40. The inner housing 40 also includes a slot that receives a threaded member inserted through the mount plate 38. The threaded member that is received through the mount plate 38 engages the slot and secures the inner housing 40 relative to the mount plate 38 and once the inner housing 40 is placed in the desired position relative to the mount plate 38.

FIGS. 7 and 8 are additional views of the mount plate 38 and the inner housing 40. The inner housing 40 includes features that receive the pin 26 on the rotating post 16. As appreciated, the inner housing 40 can be modified to accommodate other upper mount configurations.

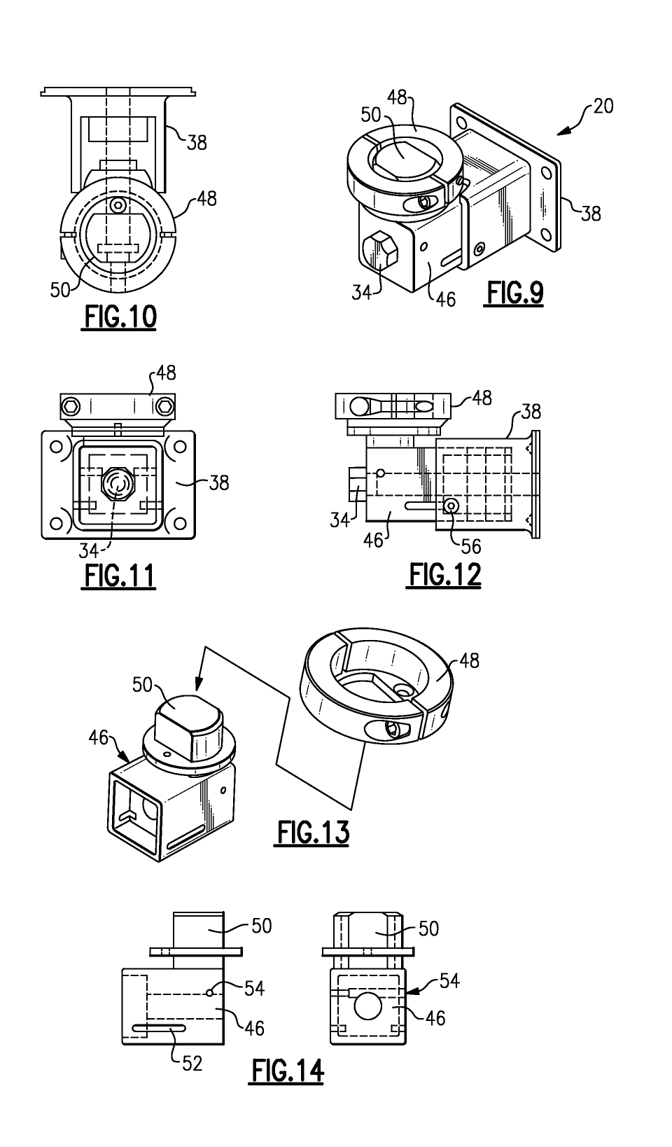

Referring to FIGS. 9-14 with continued reference to FIG. 1, the lower mount 20 also utilizes a common mount plate 38 as shown in FIG. 2 with regard to the upper mount 22. The lower mount 20 includes the inner lower housing 46 that also receives the adjusting nut 34. As in the upper mount 22, the adjusting nut 34 is held in place within the inner housing 46 by a dowel pin. The inner housing 46 also includes a clamp portion 48, the clamp portion 48 clamps around the inner support to the 24 of the rotating post 16. Additionally, the inner housing 46 includes a boss portion 50 for receiving the tube 24 and preventing the tube from coming misaligned relative to the lower mount 20.

Referring to FIGS. 13 and 14, the inner housing 46 includes the boss 50 that provides alignment of the inner support tube 24. The clamp 48 includes a plate that facilitates securement on the clamp 48 to the inner housing 46. The inner housing 46 includes an opening 34 within which a dowel pin is inserted. The dowel pin 54 is received within a groove as shown in the fastener 34 of FIG. 6. This dowel pin prevents movement of the threaded member within the inner housing and therefore provides for movement of the inner housing 46 relative of the mount plate 38.

Referring back to FIG. 1, assembly and mounting of the gate includes mounting of the upper and lower mounts 22 to corresponding support post 12. The rotating post member 16 is then supported between the two mounts by inserting a lower portion in the inner support tube 24 within the lower mount assembly.

The lower mount assembly includes the boss 50 that is adapted to fit within the inner portion of the inner support tube 24. The upper mount 22 receives the pin 26 within the cavity 42. The gates supported between the upper and lower mounts 20, 22 adjustment of the gap between the two gate assemblies 30 can now be accomplished.

Rotation of the adjustment nut 34 for each of the upper and lower mounts 20, 22 provides movement of the gate 18 in a desired direction. In other words, movement of the fastener 34 each of the lower mounts can provide for raising and lowering each of the gates independent of the upper mount 22 to provide a desired alignment of the gap 30. Additionally, adjustment of the adjustment nut 34 provides further adjustment utilized to align the gates 18 relative to each other. The example mounts 20, 22 provides sufficient adjustment in the directions indicated at 28 to close a gap between the gates 18. As appreciated, other dimensions and integrations of the upper and lower mounts 22 can be utilized to provide more or less adjustment.

Accordingly, the configuration of the upper and lower mount assemblies as disclosed provide adjustment of gate assemblies without need for removing any mount or reduces or substantially eliminates the needs for any shimming or other disassembly of the gate to provide alignment.

Although a preferred embodiment of this invention has been disclosed, a worker of ordinary skill in this art would recognize that certain modifications would come within the scope of this invention. For that reason, the following claims should be studied to determine the true scope and content of this invention.

What is claimed is:

1. A mount bracket assembly for supporting a gate comprising:
a mount securable to a support structure;
an inner housing movable supported within the mount, wherein the inner housing includes a receiving portion for receiving a portion of a gate assembly; and
an adjustment member for moving the housing relative to the mount.

2. The assembly as recited in claim 1, wherein the inner housing includes a slot and the mount includes a retaining member that extends into the slot for maintaining the inner housing movably within the mount.

3. The assembly as recited in claim 2, wherein the receiving portion comprises a cavity for receiving an upper portion of a gate assembly.

4. The assembly as recited in claim 3, wherein the cavity comprises a cylindrical opening.

5. The assembly as recited in claim 1, wherein the adjustment member extends through the inner housing and engages the mount.

6. The assembly as recited in claim 5, wherein the adjustment member comprises a threaded member and the mount includes a threaded opening receiving the threaded member.

7. The assembly as recited in claim 1, wherein the receiving portion comprises a clamp for holding a bottom portion of a gate assembly.

8. A gate assembly comprising:
a gate including a top portion and a bottom portion;
an upper bracket assembly for securing the top portion of the gate, the upper bracket assembly including an upper mount securable to a fixed structure and an upper inner housing received within the upper mount and movable relative to the upper mount; and
a lower bracket assembly for securing the bottom portion of the gate, the lower bracket assembly including a lower mount securable to the fixed structure and a lower inner housing received within the lower mount and movable relative to the lower mount.

9. The assembly as recited in claim 8, wherein the top portion of the gate includes a post and the upper inner housing includes a cavity for receiving the post.

10. The assembly as recited in claim 9, wherein the post includes a substantially spherical end portion for allowing relative movement between the upper inner housing and the gate.

11. The assembly as recited in claim 10, wherein the end portion comprises a diameter larger than the post, and the cavity includes a diameter for receiving the end portion.

12. The assembly as recited in claim 8, wherein the lower inner housing comprises a clamp for receiving and securing the bottom gate portion.

13. The assembly as recited in claim 12, wherein the clamp includes a boss for aligning the bottom gate portion within the clamp.

14. The assembly as recited in claim 8, wherein each of the upper and lower bracket assemblies include an adjustment member for moving the corresponding one of the upper and lower inner housing relative to the corresponding one of the upper and lower mount.

15. The assembly as recited in claim 14, wherein the adjustment member comprises a threaded member and each of the upper and lower mounts include a threaded opening for receiving the threaded member such that rotation of the threaded member facilitates movement of the corresponding one of the upper and lower inner housings.

16. A gate mounting kit for mounting a gate to a fixed structure, the mounting kit comprising:
an upper bracket assembly for securing the top portion of the gate, the upper bracket assembly including an upper mount securable to a fixed structure, an upper inner housing received within the upper mount and movable relative to the upper mount, and an upper adjustment member for setting a position of the upper inner housing relative to the upper mount; and
a lower bracket assembly for securing the bottom portion of the gate, the lower bracket assembly including a lower mount securable to the fixed structure, a lower inner housing received within the lower mount and movable relative to the lower mount, and a lower adjustment member for setting a position of the lower inner housing relative to the upper mount.

17. The gate mounting kit as recited in claim 16, wherein the upper inner housing includes a cavity for receiving a portion of an upper mounting post of a gate.

18. The gate mounting kit as recited in claim 16, wherein the lower inner housing includes a clamp for receiving and securing a lower portion of a gate.
